(19) United States
(12) Patent Application Publication
(10) Pub. No.: US 2004/0001305 A1
(43) Pub. Date: Jan. 1, 2004

(54) Base for supporting an electronic device at different inclinations

(75) Inventors: Ko-Chien Chuang, Taipei City (TW); Shih-Chung Kuan, Taipei City (TW)

Correspondence Address: BACON & THOMAS, PLLC, 625 SLATERS LANE, FOURTH FLOOR, ALEXANDRIA, VA, 22314

(73) Assignee: Compal Electronics, Inc., Taipei City (TW)

(21) Appl. No.: 10/179,251

(22) Filed: Jun. 26, 2002

(51) Int. Cl. G06F 1/16

(52) U.S. Cl. 361/683

(57) ABSTRACT

A base is capable of supporting an electronic device at different inclinations, and includes a seat member having a first end portion and a second end portion, a support member mounted pivotally on the seat member, and a friction hinge member having a first coupling portion and a second coupling portion coupled to the support member and the seat member, respectively, such that the support member is retained by the friction hinge member at a desired inclination relative to the seat member.

### BACKGROUND OF THE INVENTION

1. Field of the Invention

This invention relates to a base for supporting an electronic device, more particularly to a base for supporting an electronic device at different inclinations.

2. Description of the Related Art

Since there are many manufacturers producing electronic devices, such as personal digital assistants (PDA), electronic devices with multimedia functions have become very common and popular nowadays which dramatically increases people's dependency on these electronic devices in their daily lives, such as for saving or recording personal information and schedules.

Referring to FIG. 1, in order to expand the functions of electronic devices, a base 10 has been provided for supporting the electronic device 11. The base 10 has several connectors (not shown) for electrically connecting the electronic device 11 to other external peripheral devices, such as printers, monitors, or computers. However, since the base 10 is not movable, the angle of the electronic device 11 disposed thereon is fixed, which limits the viewing angle for the user. In the prior art known to the applicant, no base for supporting electronic devices at different inclinations has been provided such that the user can vary the inclination of the electronic device as desired.

### SUMMARY OF THE INVENTION

Therefore, the main object of the present invention is to provide a base for supporting an electronic device at different inclinations.

According to this invention, the base comprises a seat member, a support member mounted pivotally on the seat member and adapted to support the electronic device thereon, and a friction hinge member having a first coupling portion coupled to the support member, and a second coupling portion coupled to the seat member. The first coupling portion is pivotable relative to the second coupling portion about a pivot axis such that the friction hinge member couples the support member pivotally to the seat member and such that the support member is retained by the friction hinge member at a desired inclination relative to said seat member.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view showing a base for supporting an electronic device according to the prior art;

FIG. 2 is a perspective view of the first preferred embodiment of a base for supporting an electronic device according to this invention;

FIG. 3 is an exploded perspective view of the first preferred embodiment of this invention;

FIG. 4 is a side view showing a support member of the first preferred embodiment of this invention at a first position;

FIG. 5 is a side view showing the support member of the first preferred embodiment of this invention at a second position;

FIG. 6 is a fragmentary sectional view to illustrate a friction hinge member of the first preferred embodiment of this invention;

FIG. 7 is a front view of a second preferred embodiment of this invention; and

FIG. 8 is an exploded perspective view of the second preferred embodiment of this invention.

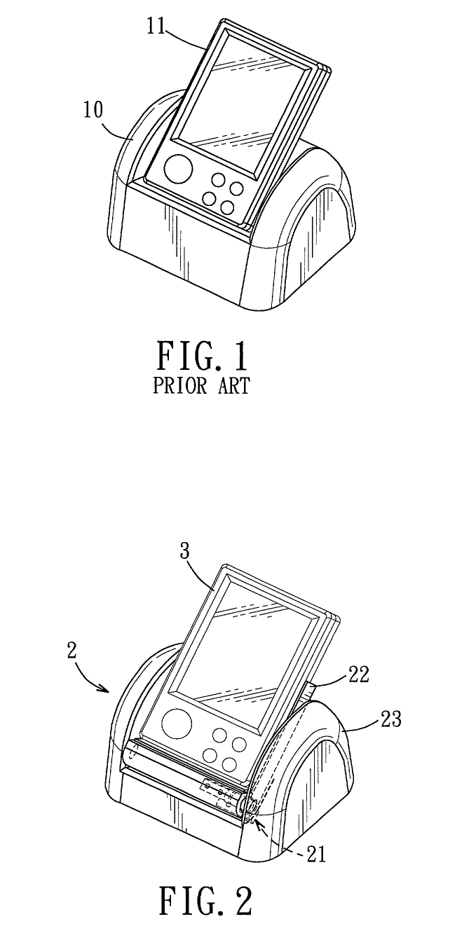

### DETAILED DESCRIPTION OF THE PREFERRED EMBODIMENTS

Referring to FIG. 2, the base 2 according to the present invention is suitable for supporting an electronic device 3, such as a PDA, at different inclinations. In a preferred embodiment of the present invention, the base 2 comprises a seat member 23, a support member 22 mounted pivotally on the seat member 23 to support the electronic device 3 thereon, and a friction hinge member 21.

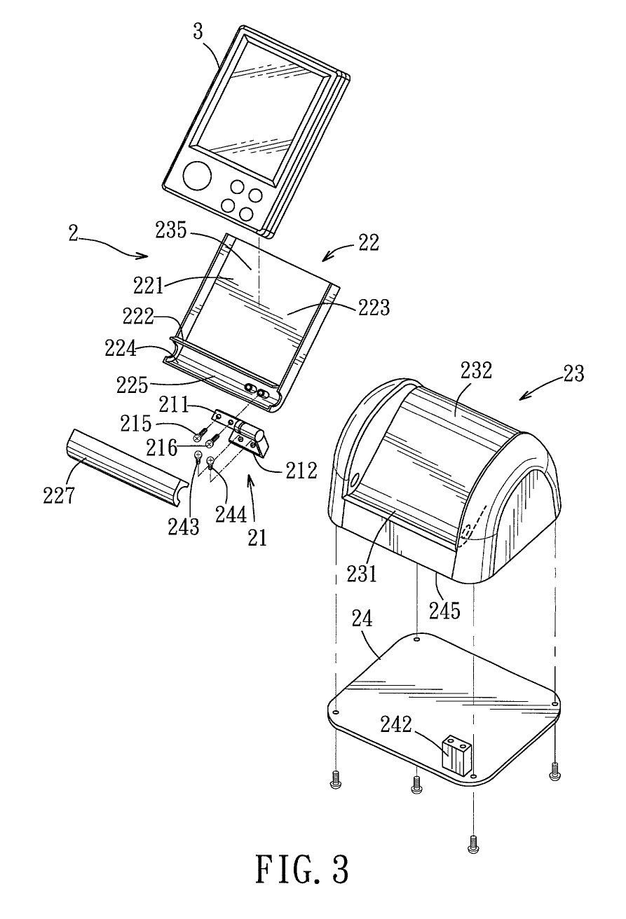

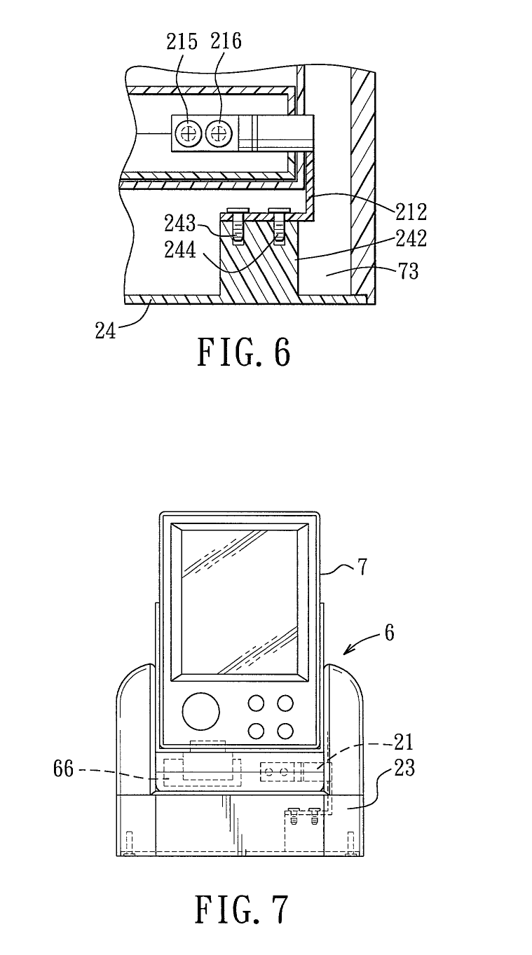

Referring to FIG. 3, the friction hinge member 21 is of the type commonly found in note book computers, and has a first coupling portion 211 coupled to the support member 22, and a second coupling portion 212 coupled to the seat member 23. The first coupling portion 211 is pivotable relative to the second coupling portion 212 about a pivot axis such that the friction hinge member 21 couples the support member 22 pivotally to the seat member 23 and such that the support member 22 is retained by the friction hinge member 21 at a desired inclination relative to the seat member 23. The seat member 23 has a first end portion 231 and a second end portion 232 opposite to the first end portion 231. The seat member 23 is hollow, confines a space 73 (see FIG. 6), and has a bottom side 245 closed by a base plate 24.

The support member 22 includes a backing portion 221 and a partition portion 222 formed on the backing portion 221 to divide the backing portion 221 into a first section 235 adapted to permit leaning of the electronic device 3 there against, and a second section 225 configured with a groove 224 for receiving the first coupling portion 211 of the friction hinge member 21 therein. The first coupling portion 211 of the friction hinge member 21 is secured to the second section 225 of the backing portion 221 of the support member 22 via screws 215, 216. The first section 235 of the backing portion 221 and the partition portion 222 of the support member 22 cooperate to form a retaining space 223 for receiving the electronic device 3. Preferably, a cover plate 227 is mounted on the second section 225 of the backing portion 221 of the support member 22 to cover the groove 224 and conceal the first coupling portion 211 of the friction hinge member 21.

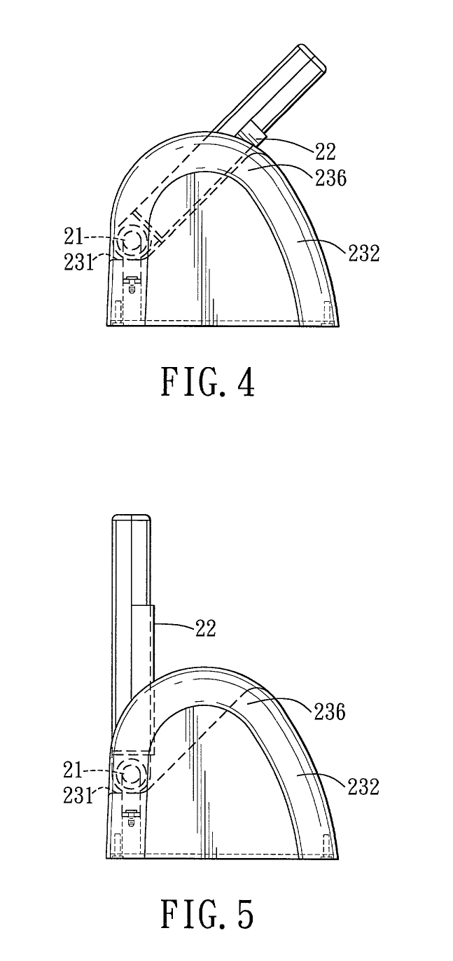

Referring further to FIGS. 4 and 5, the second section 225 of the backing portion 221 is disposed below the first section 235 and is coupled pivotally to the first end portion 231 of the seat member 23 such that the pivot axis of the friction hinge member 21 is disposed horizontally. Moreover, the second end portion 232 of the seat member 23 has a top part 236 that is disposed higher than the first end portion 231. The support member 22 is pivotable relative to the seat member 23 about the pivot axis from a first position (see FIG. 4), where the support member 22 abuts against the top part 236 of the second end portion 232 of the seat member 23, to a second position (see FIG. 5) where the support member 22 is moved away from the top part 236 of the second end portion 232 of the seat member 23.

Referring to FIG. 6, the second coupling portion 212 of the friction hinge member 21 extends into the seat member 23 and is secured inside the space 73. In this embodiment, the second coupling portion 212 extends below the first coupling portion 211 of the friction hinge member 21. Moreover, the second coupling portion 212 of the friction hinge member 21 is mounted on a mounting block 242 formed on the base plate 24 via screws 243, 244.

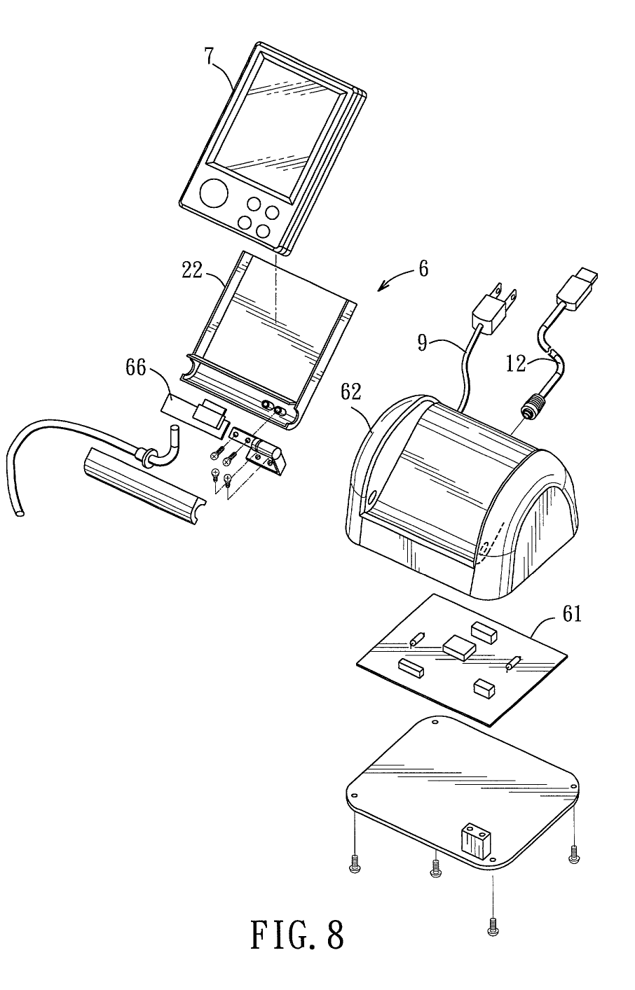

FIGS. 7 and 8 illustrate another preferred embodiment of a base 6 according to this invention. As shown, a circuit board 61 is mounted in the hollow seat member 62. A power cord 9 is connected to the circuit board 61, is disposed outwardly of the seat member 62, and is adapted to be connected electrically to an external power source. A connector module 66 is mounted on the support member 22, is connected electrically to the circuit board 61 and is adapted to be connected to the electronic device 7. As a result, power can be supplied to the electronic device 7 via the circuit board 61 and the connector module 66. In addition, a transmission cord 12 is connected to the circuit board 61, disposed outwardly of the seat member 62, and is adapted to be electrically connected to an external peripheral device (not shown), such as a printer or a monitor. Therefore, the electronic device 7 can be connected electrically to the external peripheral device via the transmission cord 12, the circuit board 61, and the connector module 66.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. A base for supporting an electronic device at different inclinations, said base comprising:
a seat member;
a support member mounted pivotally on said seat member and adapted to support the electronic device thereon; and
a friction hinge member having a first coupling portion coupled to said support member, and a second coupling portion coupled to said seat member, said first coupling portion being pivotable relative to said second coupling portion about a pivot axis such that said friction hinge member couples said support member pivotally to said seat member and such that said support member is retained by said friction hinge member at a desired inclination relative to said seat member.

2. The base according to claim 1, wherein said support member includes a backing portion and a partition portion formed on said backing portion to divide said backing portion into a first section adapted to permit leaning of the electronic device there against, and a second section configured with a groove for receiving said first coupling portion of said friction hinge member therein, said first coupling portion of said friction hinge member being secured to said second section of said backing portion of said support member.

3. The base according to claim 2, further comprising a cover plate mounted on said second section of said backing portion of said support member to cover said groove.

4. The base according to claim 2, wherein said first section of said backing portion and said partition portion of said support member cooperate to form a retaining space for receiving the electronic device.

5. The base according to claim 2, wherein said seat member has a first end portion and a second end portion opposite to said first end portion, said second section of said backing portion being disposed below said first section and being coupled pivotally to said first end portion of said seat member such that the pivot axis of said friction hinge member is disposed horizontally.

6. The base according to claim 5, wherein said second end portion of said seat member has a top part that is disposed higher than said first end portion, said support member being pivotable relative to said seat member about the pivot axis from a first position, where said support member abuts against said top part of said second end portion of said seat member, to a second position, where said support member is moved away from said top part of said second end portion of said seat member.

7. The base according to claim 5, wherein said seat member is hollow and confines a space, and said second coupling portion of said friction hinge member extends into said seat member and is secured inside said space.

8. The base according to claim 7, wherein said seat member has a bottom side closed by a base plate, said second coupling portion extending below said first coupling portion of said friction hinge member, said base plate being formed with a mounting block for mounting said second coupling portion of said friction hinge member thereon.

9. The base according to claim 1, wherein said seat member is hollow, said base further comprising:
a circuit board mounted in said seat member;
a power cord connected to said circuit board, disposed outwardly of said seat member, and adapted to be connected electrically to an external power source; and
a connector module mounted on said support member, connected electrically to said circuit board, and adapted to be connected to the electronic device;
whereby, power can be supplied to the electronic device via said circuit board and said connector module.

10. The base according to claim 9, further comprising a transmission cord connected to said circuit board, disposed outwardly of said seat member, and adapted to be connected electrically to an external peripheral device, whereby the electronic device can be connected electrically to the external peripheral device via said transmission cord, said circuit board and said connector module.

11. The base according to claim 1, wherein said seat member is hollow, said base further comprising:
a circuit board mounted in said seat member;
a transmission cord connected to said circuit board, disposed outwardly of said seat member, and adapted to be connected electrically to an external peripheral device; and
a connector module mounted on said support member, connected electrically to said circuit board, and adapted to be connected to the electronic device;
whereby, the electronic device can be connected electrically to the external peripheral device via said transmission cord, said circuit board and said connector module.
